(19) United States
(12) Patent Application Publication
(10) Pub. No.: US 2025/0045533 A1
(43) Pub. Date: Feb. 6, 2025

(54) AVERTING DISCORD BY ALIGNING CHAT IN AN AR/VR ENVIRONMENT

(71) Applicant: INTERNATIONAL BUSINESS MACHINES CORPORATION, ARMONK, NY (US)

(72) Inventors: KELLEY ANDERS, East New Market, MD (US); JONATHAN D. DUNNE, Dungarvan (IE); PAUL R. BASTIDE, Ashland, MA (US)

(21) Appl. No.: 18/364,237

(22) Filed: Aug. 2, 2023

(51) Int. Cl. G06F 40/40; G06F 3/04815; G06F 40/279; G06T 19/00

(52) U.S. Cl. CPC G06F 40/40; G06F 3/04815; G06F 40/279; G06T 19/003; G06T 2219/024

(57) ABSTRACT

An augmented or virtual reality (AR/VR) system provides an AR/VR environment in which multiple users interact and includes: a server supporting the AR/VR environment; a Chat Discord Amelioration Model (CDM) integrated with the AR/VR environment; a network interface for interfacing the multiple users with the AR/VR environment; a topic analyzer, comprising a probabilistic topic model, to generate a topic analysis based on interaction between the multiple users in the AR/VR environment, the CDM to use the topic analysis in determining misalignment in a interaction between the multiple users; and a database. The CDM receives data collected from the AR/VR environment, including data on interaction between the multiple users in the AR/VR environment. The CDM determines misalignment in the interaction between the multiple users in the AR/VR environment and generates an amelioration for the misalignment and output the amelioration to one or more of the users via the AR/VR environment.

### RELATED APPLICATION

The present specification is related to U.S. patent application Ser. No. 18/062,594, filed 7 Dec. 2022 and incorporated herein by reference in its entirety.

### BACKGROUND

The present invention relates generally to the field of computing, and more particularly to natural language processing.

Natural language processing is a field of computing that enables computers to process, translate, and practically understand natural language. As opposed to languages and formats designed or encoded for computers to understand, such as programming languages, markup languages, and databases, natural language is the type ordinarily used for communication between humans, and thus requires computing techniques such as lexical analysis artificial intelligence and machine learning to process. However, these methods enable computers to simplify user interfaces and interact with text not written specifically for computers to interact with.

### SUMMARY

In an example of the subject matter described herein, an augmented or virtual reality (AR/VR) system provides an AR/VR environment in which multiple users interact and includes: a server supporting the AR/VR environment; a Chat Discord Amelioration Model (CDM) integrated with the AR/VR environment; a network interface for interfacing the multiple users with the AR/VR environment; a topic analyzer, comprising a probabilistic topic model, to generate a topic analysis based on interaction between the multiple users in the AR/VR environment, the CDM to use the topic analysis in determining misalignment in a interaction between the multiple users; and a database. The CDM receives data collected from the AR/VR environment, including data on interaction between the multiple users in the AR/VR environment. The CDM determines misalignment in the interaction between the multiple users in the AR/VR environment. The CDM having a threshold or criteria and conducting analysis of the misalignment in the interaction between the multiple users until the threshold or criteria is met. In response to the threshold or criteria being met, the CDM generates an amelioration for the misalignment and output the amelioration to one or more of the users via the AR/VR environment.

In another example, a processor-implemented method for ameliorating misalignment in user interaction in an augmented or virtual reality (AR/VR) environment includes operating each of: a server, comprising one or more processors, the server supporting the AR/VR environment; a Chat Discord Amelioration Model (CDM) integrated with the AR/VR environment; a network interface for interfacing the multiple users with the AR/VR environment; a topic analyzer, comprising a probabilistic topic model, to generate a topic analysis based on interaction between the multiple users in the AR/VR environment, the CDM to use the topic analysis in determining misalignment in a interaction between the multiple users; and a database. The method further incudes: with the CDM, receiving data collected from the AR/VR environment, including data on interaction between the multiple users in the AR/VR environment; with the CDM, determining misalignment in the interaction between the multiple users in the AR/VR environment; with the CDM, conducting analysis of the misalignment in the interaction between the multiple users until a threshold or criteria is met, and, in response to the threshold or criteria being met, generating, with the CDM, an amelioration for the misalignment and output the amelioration to one or more of the users via the AR/VR environment.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a process for averting discord by aligning a conversation.

FIG. 3 depicts an example of an AR/VR system according to principles described in the present specification.

FIGS. 4-6 depict a flow of the operation of the system depicted in FIG. 3.

FIG. 7 is another flowchart depicting a method according to the principles described in the present specification.

FIG. 8 depicts a specific example of operation of the system of FIG. 3.

FIG. 9 is a flowchart depicting another example method according to principles described herein.

FIG. 10 depicts a computer program product according to principles described herein.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to natural language processing. The following described exemplary embodiments provide a system, method, and program product to, among other things, explain discourse to users with various skill levels. Therefore, the present embodiment has the capacity to improve the technical field of natural language processing by assessing explainability of complex discourse to aid user understanding based on user skill level.

As previously described, natural language processing is a field of computing that enables computers to process, translate, and practically understand natural language. As opposed to languages and formats designed or encoded for computers to understand, such as programming languages, markup languages, and databases, natural language is the type ordinarily used for communication between humans, and thus requires computing techniques such as lexical analysis, artificial intelligence and machine learning to process. However, these methods enable computers to simplify user interfaces and interact with text not written specifically for computers.

Natural language processing may be useful in the context of a conversation, helping moderate a public forum, social network, or chat service. However, while current solutions may use simple methods of lexical analysis to, for example, superficially moderate a web forum, these solutions function post-hoc, attempting to address full-blown arguments after they are already in progress. Furthermore, users can often speak past each other, allowing misunderstandings to develop and grow deeper over time. As such, it may be advantageous to engage in analysis of an alignment level, where misalignments include discordances, misunderstandings, disturbances, and arguments, and restore alignment or avert deeper misalignments.

According to one example, a method for averting discord by aligning a conversation is provided. The method may involve monitoring a conversation for misalignments, such as a misunderstanding or disturbance. A chat alignment model may be derived from the content of the conversation. The model may then be used to identify a misalignment or potential misalignment. Finally, the method may involve taking an action to bring the chat back into alignment, such as recommending that a user rephrase a message or providing a user with an explanation.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

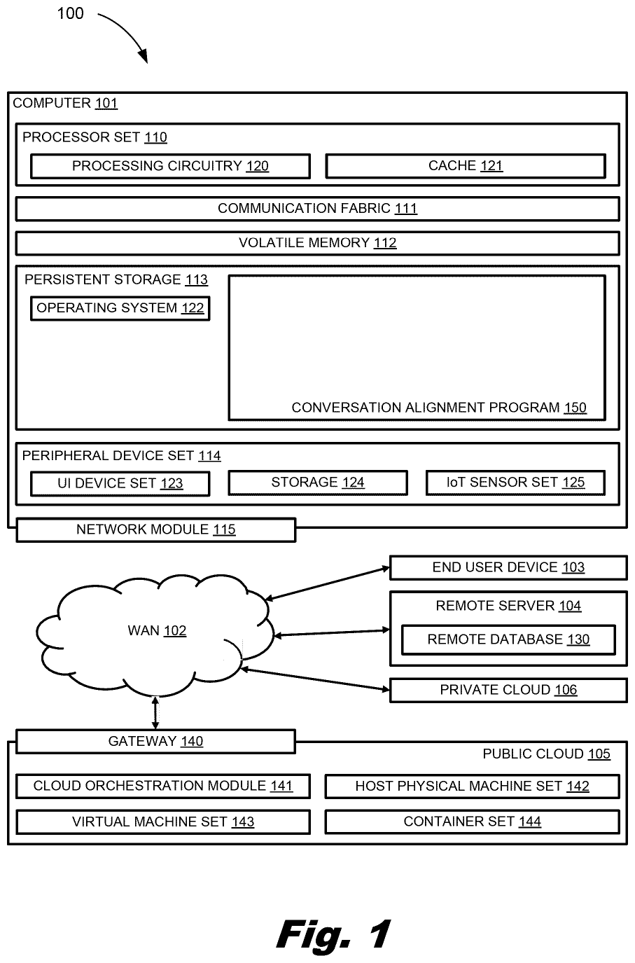

Referring now to FIG. 1, computing environment 100 contains an example of an environment for the execution of at least some of the computer code involved in performing the inventive methods, such as conversation alignment program 150. In addition to conversation alignment program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and conversation alignment program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed conversation is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in conversation alignment program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in conversation alignment program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The conversation alignment program 150 may monitor a conversation for misalignment, discord, conflict or misunderstanding. The conversation may then be used to derive a chat alignment model. The conversation alignment program 150 may use the model to identify a misalignment or potential misalignment. Upon identifying a misalignment or potential misalignment, the conversation alignment program 150 may take an action to bring the chat back into alignment or avert further misalignment, such as recommending that a user rephrase a message or providing a user with an explanation.

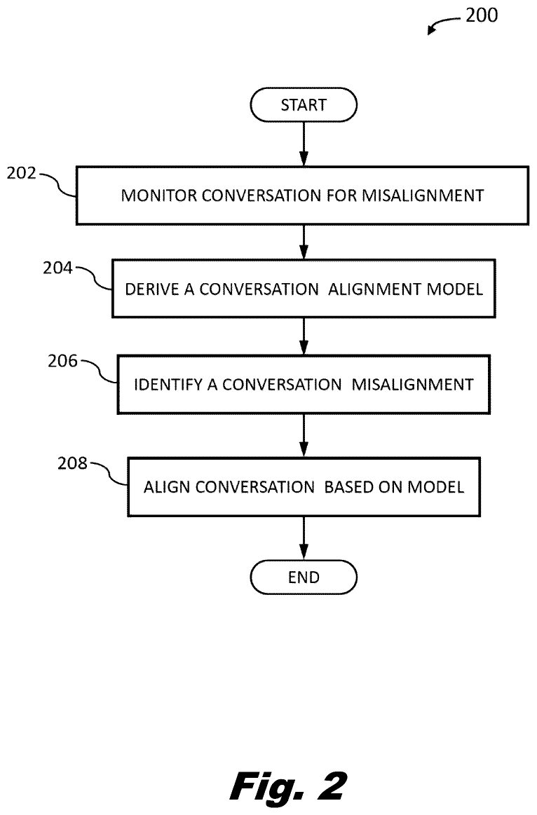

Furthermore, notwithstanding depiction in computer 101, conversation alignment program 150 may be stored in and/or executed by, individually or in any combination, end user device 103, remote server 104, public cloud 105, and private cloud 106. The discourse explanation method is explained in more detail below with respect to FIG. 2.

Referring now to FIG. 2, an operational flowchart for a process for averting discord by aligning a conversation 200 is depicted according to at least one embodiment. At 202, the conversation alignment program 150 monitors a conversation for misalignment. A conversation may be, for example, a chat between two or more users, a web forum thread, a thread on a social media service or a microblogging service, a discussion on a blog with comments, an email thread, or a larger collection of chat rooms or threads.

The term “misalignment” is used to refer generally to negative developments in the interaction between two users or participants. Misalignment may include misunderstanding, discord, or conflict among two or more users, or any other failure of the users to engage in a meeting of the minds. Misalignment may be thought of as a state of conversation where two users are communicating in a manner where there is not a “meeting of the minds,” or are “talking past each other.” For example, misalignment may include a chat room where several users are using the word “star” to refer to a celestial body, and other users are using the word “star” to refer to a celebrity. As another example, misalignment may include a scenario where an argument is beginning to form around a minor disagreement about a minor issue of taste.

Monitoring a conversation may include collecting data about messages, posts, users, and the medium in which the conversation occurs, including metadata. In at least one embodiment, monitoring misalignment may include identifying a level of misalignment, measured by a numerical value, by distinct levels, or a binary value. A numerical value may include an integer, rational number, or real number, including a percentage or a ratio, representing a degree of alignment or misalignment. A binary value may represent whether a conversation is aligned or misaligned, or whether alignment or misalignment exceeds a certain threshold. Distinct levels may include, for example, “level A,” “level B,” and “level C,” or “full alignment,” “potential misalignment,” “imminent misalignment,” and “current misalignment.” A level of misalignment may be determined based on analyzed data as described below.

Alternatively, monitoring misalignment may include identifying a type or source of misalignment. For example, types of misalignment may include “misunderstanding,” “discord,” “conflict,” and “argument.” Sources of misalignment may include a particular message, post, conversation, or user.

A conversation may be, for example, a chat or call between two or more users, an email thread or an interaction between users in virtual or augmented reality (AR/VR) environment. Alternatively, a conversation may be a web forum thread, a thread on a social media service or microblogging service, a discussion on a blog with comments, or a similar service with posts and comments. Posts and comments may each consist of text, images, video, or audio. As another alternative, a conversation may be a larger collection of chat rooms or threads, such as a whole forum, a subforum, a group of chatrooms, or a group that includes multiple media of conversation.

A conversation may be a synchronous conversation such as a chat, video call or an interaction between users in virtual or augmented reality (AR/VR) environment where users are interacting with one another concurrently, live, or in real time. Alternatively, a conversation may be an asynchronous conversation, such as a web forum or an email thread where users tend to interact on their own time, or one by one.

In another embodiment, monitoring a conversation may further include collecting data. Data may include, for example, data about a conversation, data about users, metadata, data collected for machine learning, or analyzed data.

Data and metadata about a conversation may include data about messages and posts. Such data may include the content of such messages and posts, including text, images, videos, audio, other attachments, URIs, and any other information included in messages or posts. Metadata about a message or post may include a time at which or place or device from which the message or post is sent or posted, a size or length of the post or message, or a topic of the post or message. A topic may be represented by a hashtag, by a forum or subforum in which a post is posted, or a topic of a chat room in which a message is sent.

In an alternative embodiment, data and metadata about a conversation may include data collected according to opt-in procedures about messages that are not sent, or posts that are not posted, or versions or drafts of messages that are sent or posts that are posted. Such data may be collected continuously or at any practical frequency.

Data and metadata about users may be collected according to opt-in procedures, and may include, for example, a user's preferred language, a user's location, the full set of content the user has shared, information about the user's preferences, a user's date of birth, a time at which a user joined a service or a conversation, a user's most engaged topics, or a frequency with which a user engages in the conversation.

Data collected for machine learning may include feedback collected based on actions taken at 208. For example, if the conversation alignment program 150 successfully averts misunderstanding by recommending a resource to a user, a user interface may ask a user if the resource was helpful in resolving the misunderstanding, with an option for “yes,” and “no,” or with a Universal Resource Indicator (URI) leading to a longer feedback form. Alternatively, data collected for machine learning may include alignment levels before and after a given action is taken.

Collecting data may further include analyzing data to create analyzed data. Analyzing data may include using topic modeling, corpus linguistics, Latent Dirichlet Allocation (LDA), word to vector, Jacquard Distance, natural language understanding (NLU), IBM Watson® Natural Language Understanding services (IBM Watson and all IBM Watson-based trademarks and logos are trademarks or registered trademarks of International Business Machines Corporation and/or its affiliates), Cohen's Kappa scores, or a combination or average of more than one piece of analyzed data. For example, analyzed data may include an average of distances found using multiple techniques. Data analysis may be performed using artificial intelligence, and may be used to perform machine learning, or in conjunction with a neural network. Analyzed data may be used to determine a level of misalignment as described above.

A conversation may be monitored 202 in real time, or substantially in real time, quickly enough that action may be taken at step 208, or quickly enough to avert deeper misalignment, even for synchronous conversations. Alternatively, a conversation may be monitored after the fact, such as for the purpose of machine learning, or less quickly, for the purpose of supporting asynchronous conversations.

After monitoring the conversation for misalignment 202, at 204, the conversation alignment program 150 derives or trains one or more conversation alignment models. A conversation alignment model may be formed based on analyzed data or other data collected at 202. The conversation alignment program 150 may derive one model per user, per chat, per group, per team, or per organization, or generally across a network, or in any other combination. The conversation alignment program 150 may generalize or combine multiple models into one higher-order model.

In at least one embodiment, the conversation alignment model may be derived from or trained based on the content of messages, analyzed data, feedback, or any other data collected at 202. The conversation alignment model may be trained using any variety of machine learning methods, including artificial neural networks and the data analysis methods described above.

The conversation alignment program 150 may derive multiple models, including models per user, per chat, per group, per team, or per organization. The conversation alignment program 150 may further derive one model generally across a network, or any combination of higher- and lower-order models. In an alternative embodiment, the conversation alignment program 150 may combine multiple models using techniques such as federated learning. For example, if one model is derived per organization, several organizations may engage in federated learning to derive a higher-order model.

Next, at 206, the conversation alignment program 150 identifies a misalignment in the conversation. Identifying a misalignment may include predicting a potential misalignment, identifying a misalignment that is just beginning, or identifying a misalignment in progress. A misalignment may include one message that may cause or represent a state of misalignment, a misalignment level exceeding a certain threshold, a particular type of misalignment, or a state of misalignment as identified by the conversation alignment model.

Predicting a potential misalignment may be performed using the conversation alignment model, the analyzed data, or the alignment level determined at 202. For example, if a topic of conversation relates to quantum physics, and the model suggests that Alice understands quantum physics at a much higher level than Bob, the conversation alignment program 150 may determine that the conversation is 15% likely to involve a misunderstanding when Alice is present but Bob is not, and 60% likely to involve a misunderstanding after Bob joins. Alternatively, the conversation alignment program 150 may determine that, when Charlie and David engage in a conversation that mentions their favorite sports teams, they are likely to engage in an argument within six messages.

Then, at 208, the conversation alignment program 150 takes an action to align the conversation based on the conversation alignment model. Aligning the conversation may include taking action to mitigate or prevent future misalignment or bring a conversation back towards alignment, such as by removing the cause of the misalignment or redirecting the conversation towards alignment. An action may include a recommendation to a user or moderator or a direct action taken automatically.

In at least one embodiment, an action may include a recommendation to a user. For example, a recommendation may include recommending that a user rephrase or modify a message before or after sending the message, which may display similarly to a spell-checking service, such as by a red underline under words that should be changed in a message editor. As another example, a recommendation may include suggesting that a user take a break from a social media service for an hour or the rest of the day. Alternatively, a recommendation may be to add a particular user to a conversation, where the particular user is an expert on the topic of conversation, a good mediator, or a mutual friend of two users who might argue.

As yet another example, a recommendation on a web forum may provide a resource to a user, such as a link that will help the user understand the topic of conversation to avert a potential misunderstanding. If a topic of conversation relates to quantum physics, and the model suggests that Alice understands quantum physics at a much higher level than Bob, and Bob replies to a post by Alice in the conversation dealing specifically with quantum entanglement, a resource may be selected to help Bob understand quantum entanglement better. A resource may be, for example, a link to a website, an explanation in a database, or a service that provides explanations.

In another embodiment, a recommendation may be made to a moderator or administrative user. For example, the conversation alignment program 150 may recommend that a moderator temporarily mute, suspend, or ban a user who is causing a disturbance that leads to misalignment. Alternatively, a recommendation may be that a moderator hide or remove a post or comment that is causing a high degree of misalignment.

In yet another embodiment, the conversation alignment program 150 may take direct action automatically, or direct another program to take action automatically. For example, the conversation alignment program 150 may make an automatic correction to a message or post in a context where the correction will help align the conversation or avert misalignment. Alternatively, the conversation alignment program 150 may ban a user from a conversation, or add another user to the conversation, such as an expert on the topic of conversation, a good mediator, or a mutual friend of two users who might otherwise argue.

In addition to using the conversation alignment model, the conversation alignment program 150 may make relevant determinations using the conversation analysis methods from 202 or other methods of artificial intelligence.

The conversation alignment program 150 may select the type of action, the particular action taken, and other actions based on the conversation alignment model and other factors. For example, the conversation alignment program 150 may determine, using the conversation alignment model, that some users are more open to suggestions than other users, and make suggestions to open-minded users first, and closed-minded users afterwards. Alternatively, a moderator for a web forum may change settings for the actions the conversation alignment program 150 may take to align a conversation. For example, a moderator may set a low threshold requirement for muting a user for fifteen minutes, but set a high threshold requirement for suspending a user for more than a day, or disable the conversation alignment program 150 from banning a user permanently.

The conversation alignment program 150 may select an action to maximize the average likely alignment level, minimize the risk that alignment sinks below a certain threshold, or minimize a certain form of misalignment, such as a degree of argument-type misalignment. The conversation alignment program 150 may further predict the likely effects of a given action, and determine an action to minimize other negative effects. For example, the conversation alignment program 150 may determine that, while banning Erin may reduce the likelihood of a misalignment today, Erin is usually helpful in maintaining alignment, and banning Erin may have negative long-term consequences.

It may be appreciated that FIG. 2 provides only an illustration of one implementation and does not imply any limitations with regard to how different embodiments may be implemented. Many modifications to the depicted environments may be made based on design and implementation requirements.

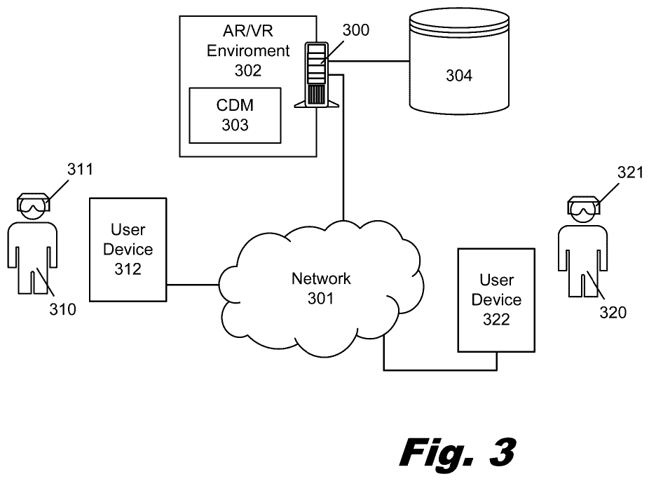

FIG. 3 depicts an example of an AR/VR system according to principles described in the present specification. An AR/VR environment, also known as metaverses, are 3D-enabled virtual worlds where social connections and presence span time and space in immersive ways. These new ways engage the person in many forms—sight, sound, movement, taste, time, interoperability across applications and modality. As we move into this new form of engagement, the line between physical reality and virtual reality or augmented reality becomes blurred. This is especially seen on digital chat platforms. We can encounter situations where a conversation needs to be ameliorated (e.g., expansion, clarification, explanation) so there is a ‘tolerable amount’ of conversation. Thus, there is a need to ameliorate synchronous communication in AR/VR.

Accordingly, a Chat Discord Amelioration Model (CDM) has been described above with respect to FIG. 2. The description will now address the application of the CDM in an AR/VR instance. Specifically, this application of the CDM ameliorates synchronous communication in AR/VR, by modeling the interval between speaking, physical (virtual distance), and communication discord, and use said model to ameliorate the conversation in augmented/virtual reality platforms. The amelioration occurs using supporting visual elements, digital twin proxies, replays, composite visuals, participant distances and intervals. This provides a high-fidelity solution which provides for a tolerable amount of conversation via supporting visual elements, such as, but not limited to avatars or overlays, or replays of prior conversations as part of the sensory amelioration.

Step 1: Chat Discord Amelioration Model (CDM) is loaded as a module in a virtual/augmented reality instance. Step 2: Data is collected from the virtual/augmented reality instance, incorporating such data points as distance of avatars to other avatars or other objects. Step 3: Outputs from Steps 1 and 2 are applied to model the point at which thresholds and criteria are met. Step 4: Amelioration—When thresholds or criteria is met, e.g. interval between speaking, physical (virtual distance), certain changes are evident in the avatar(s), or supporting visual elements or replay of prior conversations. Step 5: The model is generalized across content domains and/or per organization or department basis.

As shown in FIG. 3, a number of users 310, 320 may be able to access and interact in a virtual or augmented reality environment. Specifically, a first user 310 has a number of interface devices 311 for perceiving and interacting with the AR/VR environment. These devices 311 may include a headset with a display, headphone or earphones and a microphone. Other interface devices 311 may include haptic gloves or other devices that provide sensory output to the user 310 based on the AR/VR environment.

A user device 312 supports these peripheral devices 311 and access to the AR/VR environment. The user device 312 may be a general purpose computer or a specific AR/VR terminal device. Either may be based on the architecture described in FIG. 1.

In order to interact with other users in the AR/VR environment, the user device 312 is connected via the cloud, i.e., network 301, to a server 300 that is supporting the AR/VR environment 302 for a number of users. This may include a second user 320 who is equipped with interface devices 311 and a user device 322 similar or identical to those of the first user 310. In this system, both users provide interactions to, and receive output from, the AR/VR environment 302. Consequently, the users 310, 320 can speak and interact with each other via the AR/VR environment 302. The server 302 may include a database 304 that records the behavior and interactions of the users in the AR/VR environment 302 for later reference, as described below. This user history and previous ameliorations can also be stored locally on the user device(s) 312, 322. The system of FIG. 3 could be a gaming platform, for example.

As explained above, discord may occur in the interaction between the users 310, 320 in the environment 302 for a number of reasons including miscommunication, misunderstanding, tone, etc. This discord may also be referred to as misalignment in the interaction between the users. The CDM 303, explained above, is able to detect and quantify this misalignment between the users 310, 320 and provide output to ameliorate that misalignment. As explained above, this amelioration may take a variety of forms including, for example, providing additional resources to a user that is not understanding the subject matter of the interaction, providing additional context for the interaction based on past user interactions in the environment, providing suggestions to a user on interactions in the environment, etc.

Consequently, the CDM 303 is loaded into the AR/VR environment 302. This can be accomplished via plug-in techniques or Application Program Interface (API) calls. Once loaded into the AR/VR environment, the CDM 303 will, as explained herein, ingest data on the interactions of the users 310, 320 in the AR/VR environment. This can include all of: spoken or written communication, relative location in the environment, movement/gestures in the environment, facial expression, past user behavior and factors. In other words, the CDM 303 ingests inputs including, but not limited to, such data points as distance of users/avatars to other users/avatars or other objects, inter-arrival time of conversation, replays, composite visuals, participant distances and intervals, etc. The CDM 303 analyzes this data on the interactions of the users 310, 320 for any misalignment. When a misalignment is detected, it can be quantified. When the misalignment exceeds a threshold or meets a limit or criteria, the CDM 303 can output a corresponding amelioration to one or more of the users 310, 320 to reduce the misalignment. Some specific examples will be given below.

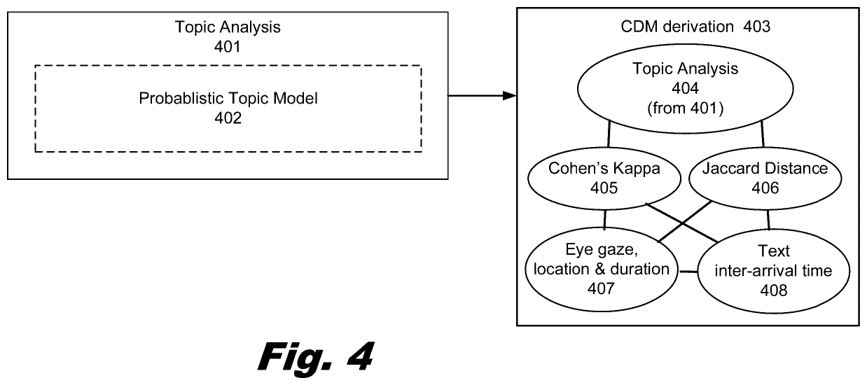

FIGS. 4-6 depict a flow of the operation of the system depicted in FIG. 3. As shown in FIG. 4, the verbal or textual conversation between users in the AR/VR environment is subjected to a topic analysis 401. Verbal communication may be converted to text for this analysis. The topic analysis 401 can include a probabilistic topic model. For example, see “Probabilistic Topic Models” by David M. Blei (Communications of the ACM, April 2012, Vol. 55, No. 4) incorporated herein by reference.

Probabilistic topic models are statistical models used to discover latent topics within a document or collection of documents. These models aim to represent the subject text as a mixture of different topics, where each topic is a probability distribution over words in the vocabulary. These models are widely used in natural language processing (NLP) and text mining tasks, such as document clustering, topic identification, and information retrieval. One of the most well-known and widely used probabilistic topic models is Latent Dirichlet Allocation (LDA), proposed by David Blei, Andrew Ng, and Michael Jordan in 2003. LDA is a generative probabilistic model that assumes the following generative process for creating a topic analysis: Choose the number of words in the text (e.g., from a Poisson distribution; Choose a distribution over topics for the text (e.g., from a Dirichlet distribution); For each word in the text: choose a topic from the topic distribution of the document and choose a word from the topic's distribution over the vocabulary.

The key idea behind LDA is that a text corpus can be represented as a mixture of topics, where each topic is characterized by the probability distribution over words. The model's parameters, such as the topic distributions for documents and word distributions for topics, are learned from the data using various algorithms, such as variational inference or Gibbs sampling. Once the model is trained, it can be used to infer the underlying topics of new, unseen documents. This inference process allows us to understand the main themes and topics present in the analyzed text.

In FIG. 4, for example, the conversation or interaction between users in the AR/VR environment includes a discussion in the field of data science that includes the concepts of Cohen's Kappa and Jaccard Distance. Cohen's kappa is a quantitative measure of reliability for two raters that are rating the same thing, correcting for how often the raters may agree by chance. Jaccard distance measures dissimilarity between sample sets.

As shown in FIG. 4, the topic analysis step 401 has produced a topic analysis 404 that issued in deriving and implementing the CDM 403. As shown, the analysis 404 identifies that Cohen's Kappa 405 and Jaccard Distance 406 are topics in the interaction or conversation under consideration. This data is combined with other data from the user interaction, for example, user behavior 407 (e.g., eye gaze direction, user avatar location or movement, statement or pause duration), text inter-arrival time 408 and other factors.

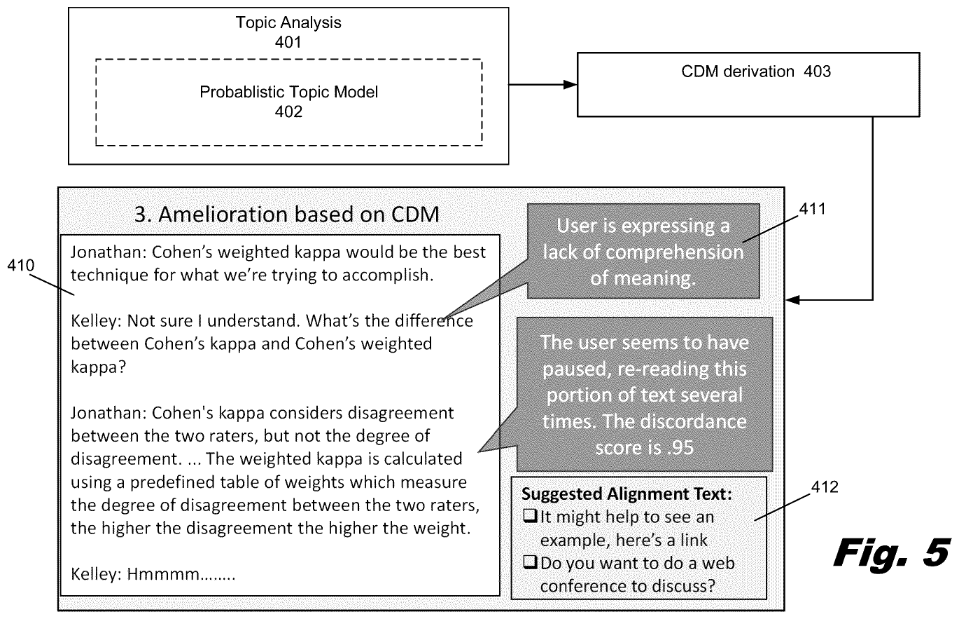

FIG. 5 further illustrates this example. As shown in FIG. 5, a relevant segment of the user interaction 410 may be as follows.
First User: Cohen's weighted kappa would be the best technique for what we're trying to accomplish.
Second User: Not sure I understand. What's the difference between Cohen's kappa and Cohen's weighted kappa?
First User: Cohen's kappa considers disagreement between the two raters, but not the degree of disagreement . . . . The weighted kappa is calculated using a predefined table of weights which measure the degree of disagreement between the two raters, the higher the disagreement the higher the weight.
Second User: Hmmmm . . .

As noted above, the topic analysis identifies that the interaction includes the topics of Cohen's Kappa and Jaccard Distance. The CDM 403, trained to recognize misalignment, operates on the interaction as depicted. Second User's first statement expresses a lack of comprehension. Second User's behavior, with pauses and re-reading portions of the text, indicates a misalignment. In this example, the CDM analysis 411 rates Second User's behavior with a discordance score of 0.95. The discordance score is a measure of the likelihood of misalignment and the need for amelioration. In this example, the discordance score is a decimal between 0 and 1. A threshold or limit may be set, for example, 0.5, at which the CDM will output an amelioration or set of ameliorations to correct the misalignment in the conversation. The amelioration may take a wide variety of forms, for example, a definition of a term of art or lesser known word, a link to related information, a video explaining a topic from the topic analysis, a replay of previous interactions with the same user that are relevant to the current conversation, etc. In the example of FIG. 5, the amelioration 412 includes a note to Second User displayed in the AR/VR environment, providing a link to an example of the subject matter that Second User does not appear to understand. The amelioration 412 may, additionally or alternatively, provide access to a web conference where further discussion of the topic in question is available. Any input that may help to resolve a misalignment in the interaction between the users may be part of the amelioration.

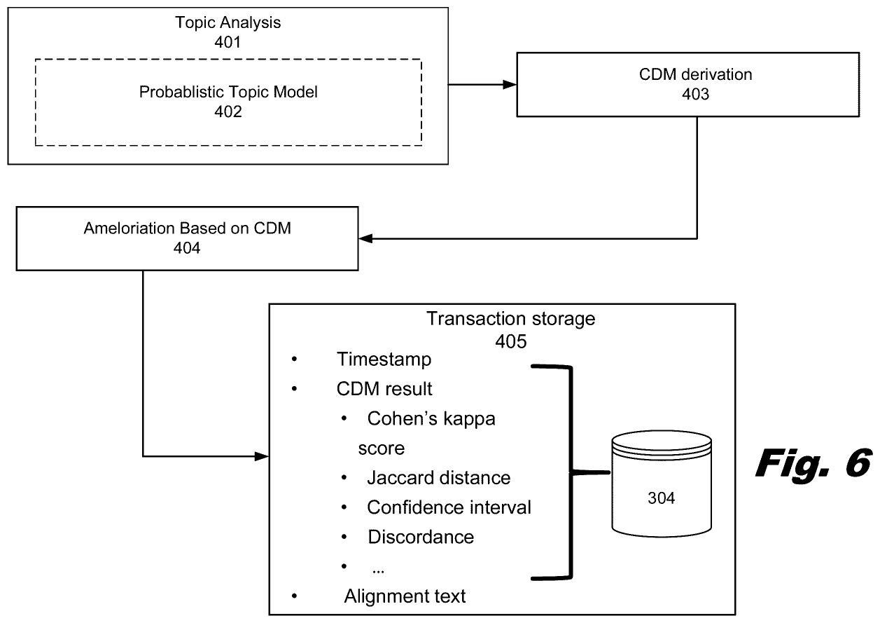

FIG. 6 further illustrates that the amelioration 404 from the CDM 403 is captured and recorded in transaction storage 405. This may include storage in the data base 304 of FIG. 3. Recording the amelioration 404 and related data allows the CDM 403 to further training on the interactions of the users so as to better identify and ameliorate misalignments.

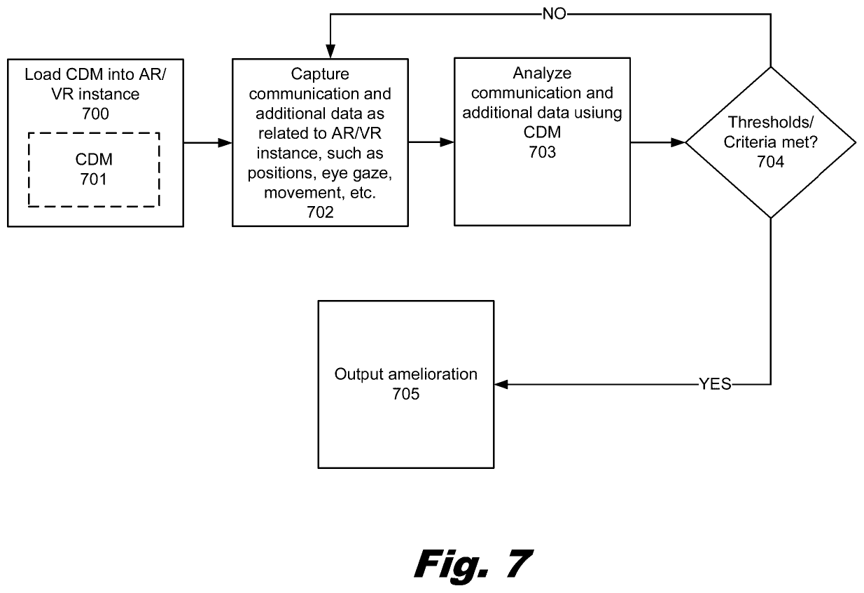

FIG. 7 is another flowchart depicting a method according to the principles described in the present specification. As shown in FIG. 7, the CDM 701 is loaded 700 into the AR/VR instance. The system then captures 702 the communication and additional data related to user interactions in the AR/VR instance. The communication and additional data are analyzed 703 by the CDM. The CDM quantifies misalignments and determines if thresholds or criteria are met 704 for output amelioration. If so, the CDM 701 outputs corresponding amelioration 705 as described above. If the applicable thresholds or criteria have not been met 704, the system continues to capture 702 interaction between the users in the AR/VR instance and analyze the communication for misalignment.

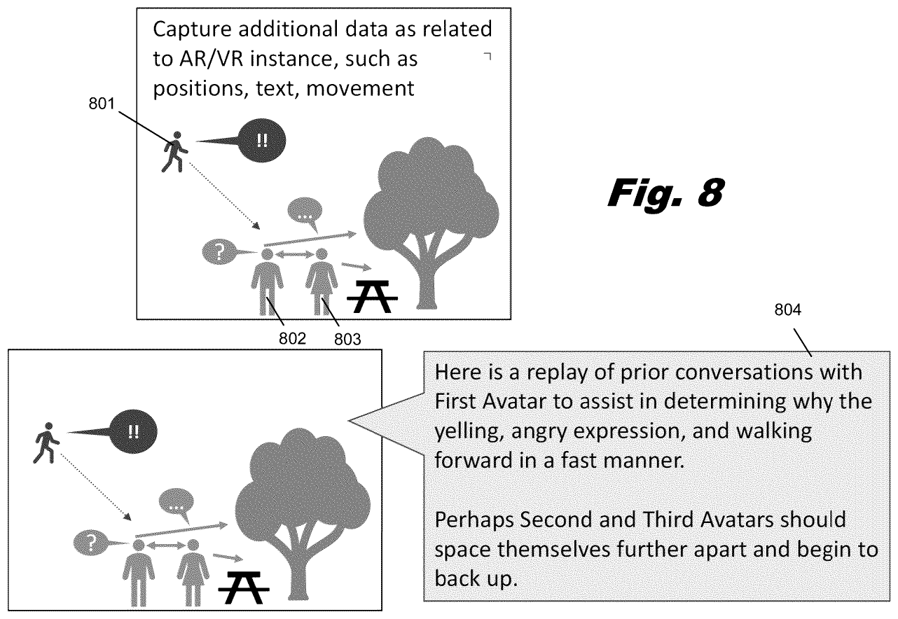

FIG. 8 depicts a specific example of the operation of the system of FIG. 3. The example of FIG. 8 may be understood as an Augment Reality (AR) instance in which the users are physically present. However, a similar example will naturally follow in which the described interaction, or a similar one, occurs in a Virtual Reality (VR) instance. Consequently, the actors in the scenario of FIG. 8 will be referred to interchangeably as users or avatars of users.

As shown in FIG. 8, a first user or first avatar 801 is rushing toward a second user/avatar 802 and a third user/avatar 803. The first user 801 is shouting or may be gesturing emphatically at the other users 802 and 803. The interaction captured may indicate that the second and third users do not understand what the first user is trying to communicate. In other words, the system detects a misalignment, as in the previous examples.

In this example, the topic analysis and collected interaction data are applied to the CDM at the point at which thresholds and criteria for amelioration are met. This could be accomplished by using techniques such as geo-fencing for locations, as well as use of Euclidian distance, and calling the CDM from step one to process certain conversations. Collected input in this example, might be as follows.

| | | | | Inter- |
|---|---|---|---|---|
| | | | | arrival |
| Object | Location | Conversation | Distance | Time |
| First | 0x87234bnsl2mr | HEY! WHAT DO | 5 meters | 40 sec |
| Avatar | | YOU THINK | and closing | |
| | | YOU'RE DOING | | |
| | | OVER THERE?! | | |
| Second | 0x234jfslk15psm | So, it looks like first | Stationary | 20 sec |
| Avatar | | avatar is walking | | |
| | | toward us quickly | | |
| | | and yelling. | | |
| Third | 0x234nspfos6n5f | Why is first avatar | Within 1 | 10 sec |
| Avatar | | yelling? What | meter of | |
| | | happened? | Avatar | |
| | | | orange | |
| Black | 0x987wbn54flods | Quiet humming - | Stationary | N/A |
| picnic | | very slow as it's a | | |
| table | | solid. | | |
| Green | 0x98235nfs89shf | A gentle | Gently | N/A |
| Tree | | thrumming, after | swaying in | |
| | | all it's a tree, | the breeze | |
| | | and it's alive | | |

When thresholds or criteria is are met, e.g. interval between speaking, physical (virtual distance), certain changes are evident in the avatar(s), or supporting visual elements or replay of prior conversations, amelioration is considered to be needed. Consequently, the CDM may output an amelioration 804 to the respective systems of the second and third user 802, 803. This amelioration 804 is based on the types of input described above, e.g., the locations of the user and recorded past interactions of the user. From this information, the CDM may determine that the first user 801 is sensitive to social distancing and has spoken about it previously. The current comments of the first user 801 may refer to social distancing, but not be intelligible to the second and third users at this point. The CDM may also, using the location information of the second and third users, determine that they are closer together than the first user would consider acceptable. For any or all of these data points, the CDM determines that the misalignment is based on the first user wanting the second and third users to better socially distance.

Consequently, the amelioration 804 is output to the systems of the second and third users to convey this intent. For example, as shown in FIG. 8, the amelioration 804 may include a replay or reference to prior interactions with the first user about social distancing. Alternatively, the amelioration 804 may simply be a suggestion to the second and third users to space themselves further apart. As will be appreciated, this is just one specific example. The CDM described may operate on any factors from the data of the AR/VR instance to determine a misalignment and output a corresponding amelioration. Lastly, the model can be generalized across content domains and/or per organization or department basis.

In other examples of the described approach, a visual of the changing conversation over time is captured and stored in the database for use in further analysis. In this way a user may see which topics are ameliorated and how it impacts the avatars. This could be used in future simulations. Conversational Discourse may be visualized for easier explanation. Attention Models may be derived from the simulations, such that amelioration techniques may be presented during the VR/AR session between two chat or conversational participants—such as a “pause” or “interlude” between two conversational participants may result in the appearance of objects related to the chat/communication to continue the conversation (or bridge the pause).

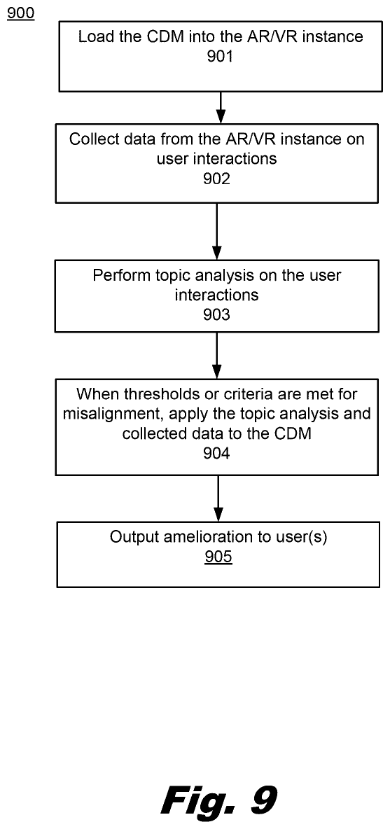

FIG. 9 is a flowchart depicting another example method according to principles described herein. As shown in FIG. 9, the method includes, first, loading the CDM into the AR/VR instance 901, as described above. Next, data is collected from the AR/VR environment 902 that characterizes or records the interaction, including behavior, between users in the environment and relevant elements of the environment, as described above. A topic analysis is performed 903 on the conversation between the users.

Using the topic analysis and the collected data, the method determines when a misalignment between the users occurs and may quantify that misalignment. When a threshold or other criteria is met, the topic analysis and collected data are applied by the CDM 904 to determine whether/how to ameliorate the misalignment. Lastly, the amelioration 905 is output to the relevant user(s) 905.

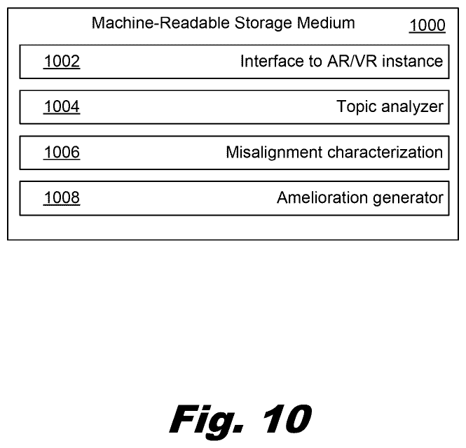

FIG. 10 depicts a computer program product according to principles described herein. As shown in FIG. 10, the product includes a machine-readable storage medium 1000 on which a CDM may be stored. This CDM includes, as described above, an interface 1002 to the AR/VR instance or environment into which it is loaded. This interface 1002 may use plug-in techniques or API calls.

The CDM also includes a topic analyzer 1004. This topic analyzer 1004 provides the topic analysis, described above, on the conversation between users in the AR/VR environment. Using this topic analysis and collected data from AR/VR environment, received through the interface 1002, the CDM characterizes misalignments 1006 in the user interaction. An amelioration generator 1008 then produces an appropriate amelioration, as described above, that is output to relevant user(s).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An augmented or virtual reality (AR/VR) system providing an AR/VR environment in which multiple users interact, the system comprising:
a server supporting the AR/VR environment;
a Chat Discord Amelioration Model (CDM) integrated with the AR/VR environment;
a network interface for interfacing the multiple users with the AR/VR environment;
a topic analyzer, comprising a probabilistic topic model, to generate a topic analysis based on interaction between the multiple users in the AR/VR environment, the CDM to use the topic analysis in determining misalignment in a interaction between the multiple users; and
a database;
wherein the CDM receives data collected from the AR/VR environment, including data on interaction between the multiple users in the AR/VR environment,
the CDM to determine misalignment in the interaction between the multiple users in the AR/VR environment,
the CDM comprising a threshold or criteria, the CDM conducting analysis of the misalignment in the interaction between the multiple users until the threshold or criteria is met,
in response to the threshold or criteria being met, the CDM to generate an amelioration for the misalignment and output the amelioration to one or more of the users via the AR/VR environment.

2. The system of claim 1, wherein the data collected comprises user/avatar location.

3. The system of claim 1, wherein the data collected comprises text inter-arrival time.

4. The system of claim 1, wherein the amelioration comprises a suggestion to the one or more users.

5. The system of claim 1, wherein the amelioration comprises a link to an additional resource related to the misalignment.

6. The system of claim 1, wherein the CDM quantifies a detected misalignment to determine whether to generate the amelioration.

7. The system of claim 1, wherein the database stores previous user behavior and interactions in the AR/VR environment, the CDM being interfaced with the database.

8. The system of claim 7, wherein the CDM further stored record of the amelioration in the database.

9. An augmented or virtual reality (AR/VR) system providing an AR/VR environment in which multiple users interact, the system comprising:
a server supporting the AR/VR environment;
a Chat Discord Amelioration Model (CDM) integrated with the AR/VR environment; and
a network interface for interfacing the multiple users with the AR/VR environment;
wherein the CDM receives data collected from the AR/VR environment, including data on interaction between the multiple users in the AR/VR environment,
the CDM to determine misalignment in the interaction between the multiple users in the AR/VR environment,
the CDM to generate an amelioration for the misalignment and output the amelioration to one or more of the users via the AR/VR environment.

10. The system of claim 9, further comprising a topic analyzer to generate a topic analysis, the CDM to use the topic analysis in determining misalignment in the interaction between the multiple users.

11. The system of claim 10, wherein the topic analyzer comprises a probabilistic topic model.

12. The system of claim 9, wherein the CDM comprises a threshold or criteria, the CDM conducting analysis of the misalignment in the interaction between the multiple users until the threshold or criteria is met, the CDM to generate the amelioration in response to the threshold or criteria being met.

13. The system of claim 9, wherein the data collected comprises user/avatar location.

14. The system of claim 9, wherein the data collected comprises text inter-arrival time.

15. The system of claim 9, wherein the amelioration comprises a suggestion to the one or more users.

16. The system of claim 9, wherein the amelioration comprises a link to an additional resource related to the misalignment.

17. The system of claim 9, wherein the CDM quantifies a detected misalignment to determine whether to generate the amelioration.

18. The system of claim 9, further comprising a database storing previous user behavior and interactions in the AR/VR environment, the CDM interfaced with the database.

19. The system of claim 18, wherein the CDM further stored record of the amelioration in the database.

20. A processor-implemented method for ameliorating misalignment in user interaction in an augmented or virtual reality (AR/VR) environment, the method comprising operating each of:
a server, comprising one or more processors, the server supporting the AR/VR environment;
a Chat Discord Amelioration Model (CDM) integrated with the AR/VR environment;
a network interface for interfacing the multiple users with the AR/VR environment;
a topic analyzer, comprising a probabilistic topic model, to generate a topic analysis based on interaction between the multiple users in the AR/VR environment, the CDM to use the topic analysis in determining misalignment in a interaction between the multiple users; and
a database;
the method further comprising:
with the CDM, receiving data collected from the AR/VR environment, including data on interaction between the multiple users in the AR/VR environment;
with the CDM, determining misalignment in the interaction between the multiple users in the AR/VR environment;
with the CDM, conducting analysis of the misalignment in the interaction between the multiple users until a threshold or criteria is met, and,
in response to the threshold or criteria being met, generating, with the CDM, an amelioration for the misalignment and output the amelioration to one or more of the users via the AR/VR environment.
